(19) United States
(12) Patent Application Publication
(10) Pub. No.: US 2009/0304897 A1
(43) Pub. Date: Dec. 10, 2009

(54) PROCESS FOR MANUFACTURING PEEL-APART PET TREATS AND PRODUCTS

(75) Inventors: Paul E. Tedman, Sabetha, KS (US); Robert L. Niehues, Parkville, MO (US)

Correspondence Address: BRADLEY S. STRAHM, 1217 MEADOWLARK LANE, SABETHA, KS, 65534, US

(73) Assignee: CROSSWIND INDUSTRIES, INC., Kansas City, MO (US)

(21) Appl. No.: 12/334,813

(22) Filed: Dec. 15, 2008

Related U.S. Application Data
(60) Provisional application No. 61/016,260, filed on Dec. 21, 2007.

(51) Int. Cl. A23K 1/00; A23L 1/10; A23K 1/18; A23P 1/12

(52) U.S. Cl. 426/623; 426/661; 426/516; 426/656

(57) ABSTRACT

A peel-apart edible pet treat and method for preparing same is disclosed in the present invention. The peel-apart edible pet treat described is characterized by a plurality of longitudinally oriented individual strands conjoined within in a compressed bundle of conjoined strands. Individual strands may be removed one-by-one in a substantially intact form from the compressed bundle of conjoined strands by pulling one of the individual strands starting at either end of the compressed bundle of individual conjoined strands. When one or more individual strands are removed, the remaining strands are still conjoined to in the bundle to provide protection from drying and flaking.

### BACKGROUND OF THE INVENTION

The present disclosure is broadly concerned with a process for manufacturing soft chew, peel apart pet treats. More particularly, it is concerned with a process for manufacturing pet treats for dogs and cats which have an appearance and texture similar to string cheese.

Pet treats are generally cheesy and/or meaty bite size biscuits, puffs, or chunks that may be formulated to have hard and crunchy or soft and chewy consistencies. In addition to classic bone and fish-shaped dog and cat biscuits, the pet food industry produces pet treats in a variety of specialty formulations such as “gourmet” and “natural organic” products. Dog treats in particular have been formulated to simulate many human snacks such as bacon strips, jerky sticks, popcorn, cookies, bagels, brownies, and pretzels. String cheese is a popular human snack having a generally cylindrical shape. It can be eaten by pulling individual strips of cheese from the cylinder along its length. It would be desirable to produce similar peel apart chewy treats for pets such as dogs and cats.

### DESCRIPTION OF THE RELATED ART

There are a number of examples of peel-apart or peelable human food products presently available to consumers. These products include the popular string cheese product which is also disclosed in by Abler et. al. in U.S. Pat. No. 5,792,497 which describes a method and apparatus for making a particular twisted variant of string cheese product. Another exemplary peel-apart human food product is Twizzlers Pull-n-peel made by The Hershey Company, about which more information can be found at www.hersheys.com/products/details/twizzler/index.asp?name=PullNPeel.

Pet owners often wish to feed their pets treats that have a similar form to those that they eat themselves. Presently, there is absent in the art a pull-apart treat for pets which mimics the afore-mentioned human food products.

### SUMMARY OF THE INVENTION

The present disclosure provides a greatly improved process for manufacturing pet treats that can be peeled apart to produce individual strips of treat material while keeping the remaining strips together in a bundle for protection from drying and flaking.

Various objects and advantages of this process and the resultant pet treats will become apparent from the following description taken in conjunction with the accompanying drawings wherein are set forth, by way of illustration and example, certain embodiments.

The drawings constitute a part of this specification, including exemplary embodiments of the manufacturing process and pet treats, and illustrate various objects and features thereof.

### BRIEF DESCRIPTION OF THE DRAWINGS

FIG. 1 is an example illustration of the subject peel-apart pet treat in the un-peeled and partially peeled state.

FIG. 2 is an example process diagram showing a process for manufacturing peel apart pet treats

FIG. 3 is an example illustration of a die plate attached to a product densification unit

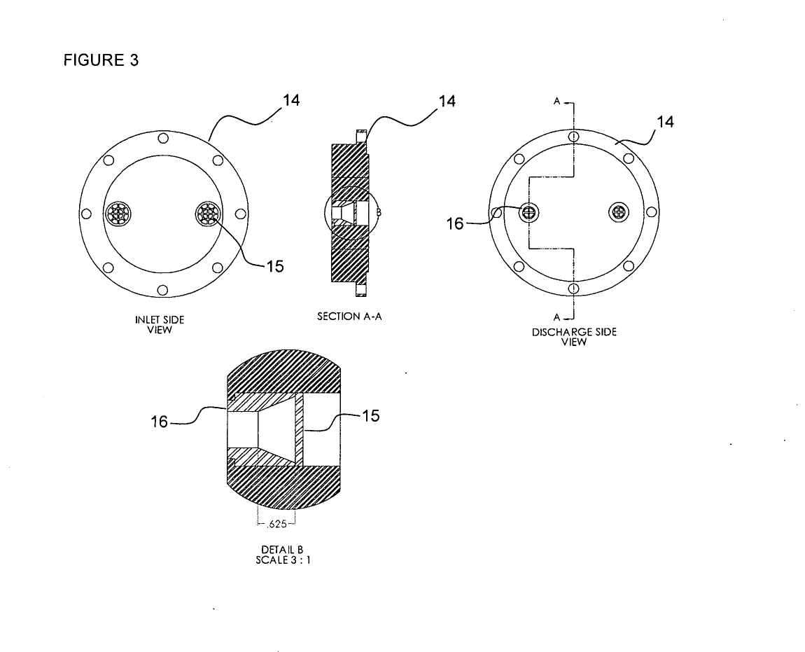

FIG. 4 is an example illustration of a strand-forming die plate

FIG. 5 is an example illustration of a conjoined strand-bundle compression orifice

### DETAILED DESCRIPTION

As required, detailed embodiments of the process for manufacturing peel apart pet treats are disclosed herein; however, it is to be understood that the disclosed embodiments are merely exemplary of the process and the treats, which may be embodied in various forms. Therefore, specific structural and functional details disclosed herein are not to be interpreted as limiting, but merely as a basis for the claims and as a representative basis for teaching one skilled in the art to variously employ the apparatus in virtually any appropriately detailed structure.

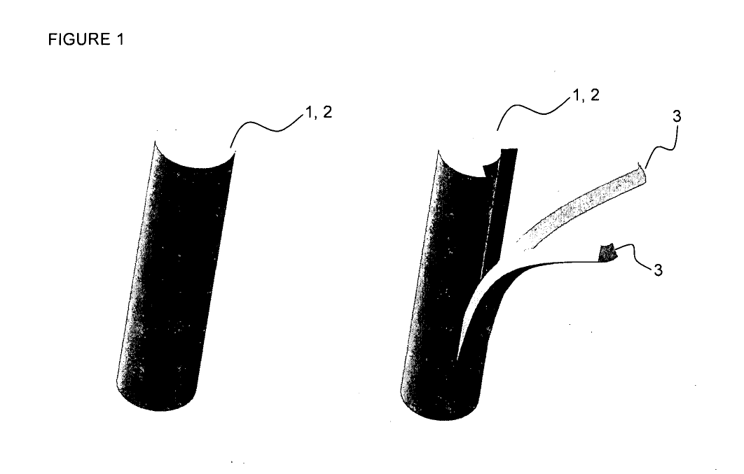

Referring now to the drawing figures, the subject peel-apart pet treat 1 is illustrated in FIG. 1 where both the bundle of compressed strands 2 is shown and an illustration showing of two of the strands 3 partially pulled or separated from the bundle of compressed strands 2.

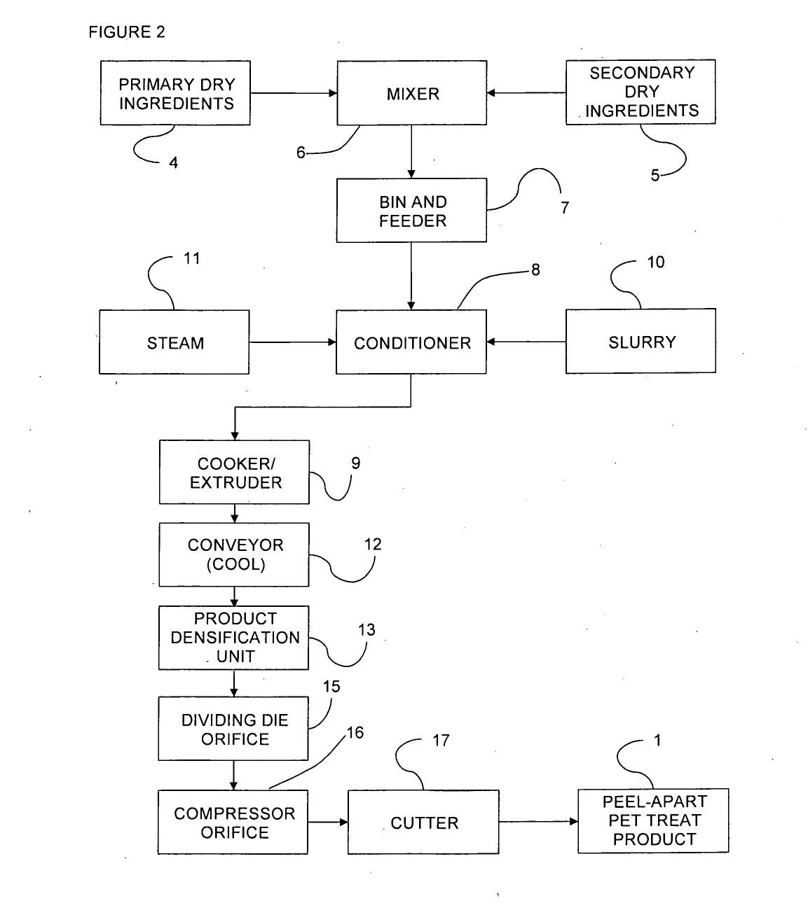

FIG. 2 shows a process for manufacturing peel apart pet treats 1 including the step of providing a quantity of dry ingredients. The dry ingredients include quantities of both primary and secondary ingredients 4 and 5. The primary ingredients 4, include various types of flour, such as wheat flour, corn flour, soy flour, gelatin, salt, wheat gluten, potassium chloride and potassium sorbate, and any other suitable major ingredient commonly found in pet food products, and combinations thereof. The secondary dry ingredients 5 include one or more of cheese powder, antioxidants, dyes, and bleaching agents, including calcium sulfate, titanium dioxide, Alphadim and Pet-Ox Plus, and combinations thereof. The dry ingredients may be preblended or mixed and ground by a hammer mill. They may be shipped and delivered by pneumatic tanker truck for storage in bins at the manufacturing facility or they may be prepared at the manufacturing facility starting from individual ingredients.

The primary and secondary dry ingredients 4 and 5 may be transferred into the manufacturing plant from the storage bins via a pneumatic conveying system or any other suitable method. A predetermined quantity of each of the primary dry ingredients is conveyed to a hopper, which is located on or equipped with a scale for weighing the primary dry material 4.

The weighed material is then discharged into a mixer 6 where the material is next mixed. While in the mixer 6, predetermined quantities of each of the secondary dry ingredients 5 are conveyed, either pneumatically or by other suitable means, to the mixer 6, and blended with the primary ingredients 4. At the conclusion of the mixing cycle, the blended dry ingredients are transferred via a pneumatic conveying system or other suitable means to the cooker extrusion system.

The cooker extrusion system includes a feed bin and feeder 7, conditioner 8, and a cooker/extruder 9. The dry material is held in the feed bin, which acts a surge for the cooker extrusion system. From the feed bin, the mixed dry material is metered into the conditioner 8 via the feeder 7. The feeder 7 is arranged on a variable speed system in order to control the mass flow of the material into (and out of) the cooker extruder system. The conditioner 8 is a twin shaft, continuous mixer.

A quantity of liquid slurry 10 is provided for mixing with the dry ingredients. The slurry 10 includes a mixture of corn syrup, chicken meat, water, propylene glycol, glycerin, phosphoric acid, cheese flavor, and poultry fat. The slurry 10 is prepared in a mixing tank, where the temperature is maintained at about 140° F. The slurry 10 is metered from the slurry tank into the conditioner 8 via a pump and flow meter system.

In the conditioner 8, the dry material, and the slurry 10 are mixed together. Saturated steam 11 is injected into the conditioner 8 to start the cooking process.

Preselected quantities of other ingredients may be added to the material in the conditioner 8, including, for example, quantities of dye, water, fat, and combinations thereof. The fat may be provided, for example, in the form of an oil, such as canola oil. The temperature of the material exiting the conditioner 8 may be controlled by the quantity of steam 11 added to the conditioner 8. In this application, the temperature of the product at the discharge of the conditioner 8 is about 212° F.

In the next step, the material discharged from the conditioner 8 enters the barrel of the cooker/extruder 9. An exemplary cooker/extruder 9 is available from Extru-Tech, Incl, Model E525, some specifications for which are available at www.extru-techinc.com. The exemplary cooker/extruder 9 is a high speed screw conveyor designed to tranform electrical energy into mechanical energy. The extruder screw configuration may be altered, depending on process requirements. The cooker/extruder 9 includes a die plate adjacent to the exit port that restricts the flow of extrudate. Such restriction causes the pressure of the material inside the extruder to increase. One exemplary die plate includes 5 extruder inserts, with each insert having 16 openings, each opening having a diameter of 3.2 mm. Since the material is heated in the cooker/extruder to at least about 212° F., the boiling point of water, and the material contains a certain quantity of water, and the material is pressurized to above atmospheric pressure within the cooker/extruder, the homogenous extrudate in the cooker/extruder will expand as it exits through the cooker/extruder die as the super-heated water in the extrudate flashes to steam and water vapor at the cooker/extruder exit.

The cooked or semi-cooked product exits the extruder die via the previously mentioned extruder inserts. The multiplicity of extrudate streams formed from each insert facilitates reduction of the product mass to enable flash-off of the maximum quantity of water vapor. However, those skilled in the art will appreciate that the extruder exit die may include a greater or lesser number of apertures to accomplish water vapor flash off and cooling of the cooked or partially cooked extrudate.

The streams of extrudate fall onto a conveyor belt 12 where they are exposed to atmospheric pressure and ambient temperature. The product is next permitted to cool on the conveyor belt 12 until it reaches a temperature below 212° F. or the boiling point of water.

The belt conveyor 12 next transports the partially cooked product to the feed port of the product densification unit 13. An exemplary product densification unit is available from Extru-Tech Inc., Model E750, some specifications for which are available at www.extru-techinc.com. The product densification unit 13 is an extrusion device having a low speed, larger diameter extruder barrel. This apparatus is designed for low shear operation, whereby minimal mechanical energy will be transmitted to the extrudate. If the product temperature in the product densification unit is maintained below about 212° F., expansion at the exit port die plate attributable to water vapor flash will be minimized.

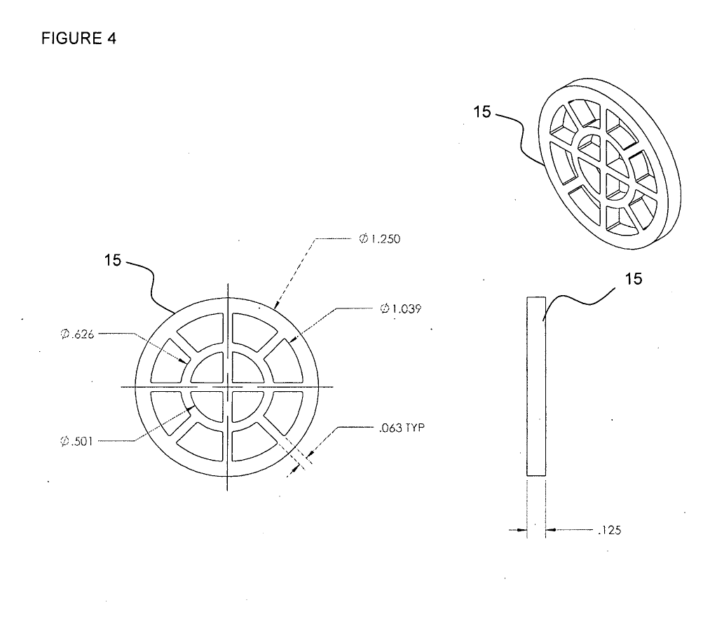

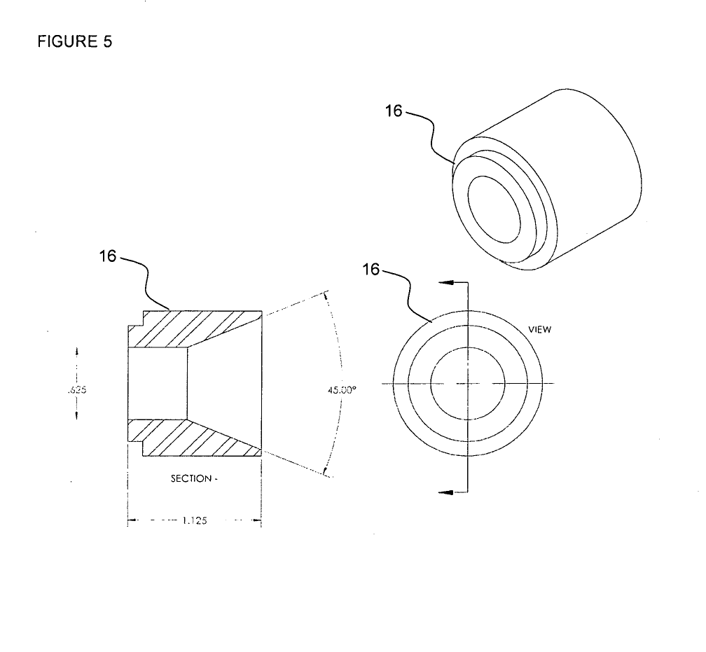

The product densification unit includes a die plate 14 (illustrated in 3) having two dividing extrusion die inserts 15 (also further illustrated in FIG. 4) each having an exemplary diameter of about 1.25 inches, and an exemplary thickness of about 0.125 inch. The dividing die inserts 15 divide the flow of material into a plurality of discrete streams, such as, for example, about 12 streams. After the material passes through the dividing inserts 15, the different streams or strands are compressed or conjoined back together via a compressor die orifice 16 (also further illustrated in FIG. 5) which is a circular orifice having a tapered inlet section. An exemplary exit compressor orifice 16 has a diameter of about 0.625 inch. The material exits the compressor die orifice 16 in a rope like fashion, and is, for example, approximately 0.700 inch in diameter. The illustrated die 14 produces two such ropes.

The ropes are transferred continuously to a cutting mechanism 17 which cuts them into treats 1 having a predetermined length, such as, for example, about 3 inches. Following cutting the treats are cooled in a two pass belt cooler and boxed for finished packaging.

While the peel-apart pet treat 1 product may present a generally cylindrical appearance, the cylindrical shape contains conjoined individual strands 3 and these individual strands 3 may be peeled off one by one by a user starting from either end of the compressed bundle 2 of conjoined strands 3 of the peel-apart pet treat 1 for providing a treat to a pet as desired. Advantageously, the remaining unpeeled strands remain conjoined in a compressed bundle 2 and are thereby protected from drying and flaking and provide the user with the additional experience of removing additional individual strands 3 from the compressed bundle of conjoined strands 2.

The preferred embodiment of the present invention is further expressed by the following example.

### Example 1

Dry ingredients were prepared by mixing the following ingredients in the ratios indicated below:
29.4% Wheat flour
21.2% Corn Flour
16.3% soy flour
10.6% Pregelatinized corn flour
7.3% Gelatin
4.9% cheese powder
2.9% vital wheat gluten
2.4% calcium sulfate
1.6% titanium dioxide
1.2% salt
0.9% potassium chloride
0.8% emulsifier
0.5% potassium sorbate
0.05% antioxidant
   Liquid ingredients were prepared by mixing the following in the ratios indicated below to create a liquid slurry:
36.3% Corn syrup
30.2% chicken meat
12.1% water
9.1% propylene glycol
9.1% glycerin
3% phosphoric acid
0.3% cheese flavor
   The liquid and dry ingredients were metered into a twin-shaft conditioner where steam and poultry fat were added. The conditioner discharged into a Extru-Tech E525 single screw cooking extruder where the ingredients were partially cooked. The cooking extruder die had 5 inserts, each with 16 openings at 3.2 mm diameter each. The partially cooked material traveled on a conveyor belt where it was cooled, then delivered into a Extru-Tech E750 product densification extruder. The discharge of the product densification extruder was capped with a die having two compressing orifices each preceded by one product separation insert. Each product separation insert had 12 product separation orifices. After exiting the compressing orifices, the product was cut to length, cooled, and packaged.
   Conditions for the process were as follows:
Dry feed rate: 1225 lbs/hr
Slurry rate: 660.38 lbs/hr
Poultry fat rate: 30 lbs/hr
Process water (steam): 80 lbs/hr
Conditioner discharge temperature: 215 F
Extruder RPM: 400
Extruder Amps: 61
Cooling all barrel jackets
Product densification unit RPM: 57
   Finished product composition:
Moisture: 21.74%-22.15%
Protein: 17.3%-17.6%
Fat: 6.16%-6.35%
Glycerin: 2.9%-3.1%
Propylene glycol: 2.9%-3.1%
Starch: 29%-32%
Number of conjoined strands: 12
Cut length: 3.5 to 3.8 inches
Product diameter: 0.7 inches

It is to be understood that while certain forms of the peel-apart pet treat have been illustrated and described herein, it is not to be limited to the specific forms or arrangement of parts described and shown.

We claim:

1. A peel-apart edible pet treat having a plurality of longitudinally oriented individual strands conjoined within in a compressed bundle of conjoined strands where said individual strands may be removed one-by-one in a substantially intact form from said compressed bundle of conjoined strands by pulling one of said individual strands starting at either end of said compressed bundle of individual conjoined strands.

2. The peel-apart edible pet treat of claim 1 where said individual strands are not are not externally visible in said compressed bundle until they are individually separated by pulling one of said individual strands.

3. The peel-apart edible pet treat of claim 1 where the length of said compressed bundle of conjoined strands is from about 0.5 inch to about 12 inches.

4. The peel-apart edible pet treat of claim 3 where said length of compressed bundle of conjoined strands is from about 2 inches to about 6 inches.

5. The peel-apart edible pet treat of claim 4 where said length of compressed bundle of conjoined strands is from about 3.5 inches to about 3.8 inches.

6. The peel-apart edible pet treat of claim 1 where the transverse cross section of said compressed bundle of strands is comprised of one or more common geometric shapes selected from the group comprised of circular, triangular, polygonal and combinations thereof, where said cross section is completely bounded by a circle having a diameter dimension.

7. The peel-apart edible pet treat of claim 6 where said diameter dimension is from about 0.25 inch to about 2 inches.

8. The peel-apart edible pet treat of claim 6 where said diameter dimension is from about 0.5 inch to about 1 inch.

9. The peel-apart edible pet treat of claim 8 where said diameter dimension is about 0.7 inch.

10. The peel-apart pet treat of claim 1 having a composition comprised of from about 16 to about 35% moisture, from about 10 to about 30% protein, from about 3 to about 12% fat, from about 15 to about 60% starch, from about 0% to about 10% glycerin, and from about 0% to about 10% propylene glycol.

11. The peel-apart pet treat of claim 10 having a composition comprised of from about 20 to about 24% moisture, from about 13 to about 17% protein, from about 6% to about 7% fat, from about 25% to about 35% starch, from about 2.5% to about 6% glycerin, and from about 2.5% to about 6% propylene glycol.

12. The peel-apart pet treat of claim 1 where the number of said individual strands is from about 2 to about 30.

13. The peel-apart pet treat of claim 12 where said number of individual strands is from about 8 to about 16.

14. The peel-apart pet treat of claim 13 where said number of individual strands is about 12.

15. A method for preparing a peel-apart edible pet treat having a plurality of longitudinally oriented individual strands conjoined within in a compressed bundle of conjoined strands where said individual strands may be removed one-by-one in a substantially intact form from said compressed bundle of conjoined strands by pulling one of said individual strands starting at either end of said compressed bundle of individual conjoined strands.

16. The method of claim 15 comprised of an extrusion process wherein an extrudate is formed and where said compressed bundle of conjoined strands is formed by passing said extrudate through first dividing die orifices and subsequently through second compressing die orifice located a distance downstream from said dividing die orifices.

17. The method of claim 16 where said extrusion process is comprised of the steps of providing dry and liquid ingredients to a conditioner to produce a conditioned stream of ingredients, passing said stream of conditioned ingredients into a cooking extruder to produce one or more streams of cooked or partially cooked material, cooling said streams of cooked or partially cooked material on a conveyor belt to produce a cooled material, passing said cooled material to a product densification extruder to provide said extrudate for passing through said dividing die orifices and said compressing die orifice.

18. The method of claim 17 where said dry ingredients are comprised of flour, wheat flour, corn flour, soy flour, gelatin, salt, wheat gluten, potassium chloride, potassium sorbate, cheese powder, emulsifiers, antioxidants, dyes, bleaching agents, and other ingredients commonly found in pet food products and combinations thereof.

19. The method of claim 16 where said liquid ingredients are comprised of steam, water, corn syrup, meat, propylene glycol, glycerin, acid, cheese flavor, fat, oil, dye, and other ingredients commonly found in pet food products and combinations thereof.

20. The method of claim 16 where said conditioned stream of ingredients reaches a temperature of at least about 160° F.

21. The method of claim 20 where said conditioned stream of ingredients reaches a temperature of at least about 200° F.

22. The method of claim 16 where said stream of cooked or partially cooked material reaches a temperature greater than about 212° F. within said cooking extruder and said stream of cooled materials reaches a temperature less than about 212° F. prior to introduction to said product densification extruder.

23. The method of claim 16 where said extrudate has a temperature less than about 212° F. when passed through said dividing die orifices and said compressing die orifice.

24. The method of claim 15 where said compressed bundle of conjoined strands is cut to a length.

25. The method of claim 24 where said length is from about 0.5 inch to about 12 inches.

26. The method of claim 25 where said length is from about 2 inches to about 6 inches.

27. The method of claim 26 where said length is from about 3.5 inches to about 3.8 inches.

28. The method of claim 16 where the ratio of said dividing die orifices to said compressing die orifices is from about 2 to about 30.

29. The method of claim 28 where the ratio of said dividing die orifices to said compressing die orifices is from about 8 to about 16.

30. The method of claim 29 where the ratio of said dividing die orifices to said compressing die orifices is about 12.

31. The method of claim 16 where said compressing die orifice has a first tapered section followed by a non-tapered section.

32. The method of claim 31 where said non-tapered section has a cross section in the direction of flow comprised of one or more common geometric shapes selected from the group comprised of circular, triangular, polygonal, and combinations thereof, where said cross section is completely bounded by a circle having a diameter dimension.

33. The method of claim 32 where said diameter dimension is from about 0.2 inch to about 1.8 inches.

34. The method of claim 33 where said diameter dimension is from about 0.4 inch to about 0.9 inch.

35. The method of claim 34 where said diameter dimension is about 0.625 inch.

36. The method of claim 16 where said distance from said dividing die orifices and said compressing die orifice is from about 0 inch to about 6 inches.

37. The method of claim 36 where said distance is from about 0 inch to about 1 inch.

38. The method of claim 37 where said distance is from about 0 inch to about 0.5 inch.
